(19) United States
(12) Patent Application Publication
(10) Pub. No.: US 2010/0287120 A1
(43) Pub. Date: Nov. 11, 2010

(54) METHOD AND APPARATUS FOR PRICING PRODUCTS

(75) Inventor: Laurent Pradere, London (GB)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: BeBook, Paris (FR)

(21) Appl. No.: 12/435,578

(22) Filed: May 5, 2009

(51) Int. Cl. G06Q 10/00; G06Q 30/00; G06F 21/00; G06F 17/30

(52) U.S. Cl. 705/400; 726/4; 707/E17.005

(57) ABSTRACT

A computer aided method and system determines a product price for sale of a product that is subsequently sold. A server receives a request from a user to access a stored first price-list, the first price-list comprises at least a product record comprising a product reference and a product price. The server allows the authenticated user to access the first price-list and creates a second price-list associated with the user. A new product record is created in the second price list that is linked to a product record of the first price-list and comprises a product reference and a product price. The price of the new product record is determined from the price contained in the linked product record of the first price-list, so that any change in the price of the first price-list generates an update of the price of the new product record in the second price-list.

### BACKGROUND

The invention relates to the field of computer-based pricing of products and services.

To simplify the reading of the following text, the term “product” will be used generically to refer to tangible products as well as intangibles products and services.

Most businesses create, update and distribute products and related pricing to their partners, intermediaries and end-customers. Those prices per product are subject to change and need to be maintained.

Those prices might be specific per product, per intermediary, service provider, per end-customer or per any other partner.

The term “intermediary” will be used generically to refer to individuals or entities that resell or assist to resell the product. Examples of intermediaries are distributors, intermediary and agents.

The term “Service provider” will be used generically to refer to individuals or entities that provide third-party services that are proposed jointly with the product. The prices or costs for those services being proposed may or may not be included in the end-customer price. “Service provider” identifies individuals or companies such as national or international freight forwarders, shippers, delivery services companies, insurance companies.

The term “End-customer” refers to either a single person as well as to purchasing entities such as companies that will purchase the product and retain the title.

Most of those businesses gather the prices for products and services specific for an intermediary, a customer, service provider or any other partner in one file or document. This document is usually called a “price-list” (or “price-book” or “catalog”).

Some of those businesses distribute those price-lists to the appropriate intermediary(s), customer(s), service provider(s) or partner(s). Some other businesses do not distribute those price-lists: they use the price-lists internally or within a computer system to create quotes for a customer, intermediary or in response to a partner's request.

The increase of competition, the transparency the customers expect, and the ability for customers to compare products drive sales and marketing teams to adjust product pricing (and therefore the product price-lists) on a frequent basis.

Large customers or resellers leverage their purchasing power to request from manufacturers, intermediaries and services providers more aggressive “special pricing” for all or part of the product portfolio. They may also request the creation of products, services, or bundles that are specific to their needs.

The globalization of the economy and the research of economies of scale drive global organizations to require global pricing from their suppliers. Global pricing represents prices that will have a rational structure to ensure some level of consistency on a global basis. For instance, a manufacturer of PCs may propose to offer the same price for similar products around the world, excluding freight and duties and based on agreed upon exchange rate value. Another manufacturer may propose a consistent discount worldwide.

An exemplary pricing relationship between a manufacturer A having 3 products, a manufacturer B having 4 products, two intermediaries R1 and R2 selling products of A and B, and a service provider P in charge of delivering the products is described below.

In the prior art, in each partner of the price-list chain, (e.g., manufacturer, intermediary, service provider, etc.) a computer database contains the price list. The database is connected to the central billing and financing system so that, for each customer order, the pricing calculation can be performed.

Manufacturer A creates a price-list for a list of 3 products: (productA1, productA2, productA3), FIG.1.

A creates and maintains this price-list for its two intermediaries R1 and R2 that may use it to sell its products to its customers according to the intermediary agreement the customers signed with Manufacturer A.

Manufacturer B creates a price-list for a list of 4 products: (productB11, productB12, productB13, product B14), FIG. 2.

A and B create and maintain their price-lists for a number of intermediaries. Among them, A and B authorized the two intermediaries R1 and R2 to use their respective price-list to purchase their products, create their own price-lists, and sell to their customers according to the specific terms and conditions of the agreement.

R1 and R2 receive the price-lists from the Manufacturers A and B.

Intermediaries R1 and R2 might create their own price-list that they might either use internally or distribute to their customers

The following are the steps Intermediaries R1 or R2 follow to create their own price-lists. R1 proceeds (R2 would do similarly), for example, by:
Selecting the products it will distribute;
Associating the vendor's Part Number with R1's specific Part Numbers;
Defining R1 pricing rules. R1 may select from several pricing methodologies, including, but not limited to:
   Setting prices based on the Manufacturer's prices to R1 by a markup based on marginal increments: R1_Price_to_customer=Manufacturer_price_to_R1×(1+markup %);
   Setting arbitrary price such as with eye-appealing prices: ProductA price=$9.99;
   Setting prices based on R1 list prices: R1_Price_to_Customer=Manufacturer_Recommended_public_price;
Applying a rule to calculate the resulting price for R1's customers;
Creating a price-list R1 will distribute to its customers;
Specifying the appropriate Terms and Conditions associated to R1's price-list to its customers; and
Specifying the pricing validity dates or any other component that might constitute the price-list

FIG. 3 shows, as an example, the price-list resulting of this process.

FIG. 4 shows the table that R2 creates to list the products and calculate the related prices as required to build its price-list.

The lines checked in the “Select” column are products that R1, or R2, selects to include into its own price-list, since sometimes intermediaries select only part of the catalog of their vendors. Pricing rules are not always disclosed, particularly to consumers. However, they are generally disclosed when the prices are the outcome of applying negotiated contractual discounts to list prices.

The end-customer C1, purchasing from both R1 and R2, will use the respective price-list from those intermediaries.

Every time Manufacturer A or Manufacturer B update their respective price-list, A or B will notify their authorized intermediaries and service providers that the price-lists have been updated and provide them with the new price-list as a document and/or a file. The intermediaries R1 and/or R2 will then use the updated manufacturer price-list to update prices and/or cancel, modify or add products for their own customers.

Intermediaries will proceed in the sequence described above: uploading the updated manufacturer price-list, re-entering the pricing rules that have been applied to the previous price-list, potentially modifying these rules, and deciding on what price or rule to apply to newly launched products. Once the intermediaries have updated their price-list, they make the updated price-list available to their customers and, often when customers are identified, send them the updated price-list.

If an intermediary has selected a new product for distribution, the service provider SP providing the delivery service will propose a price for delivering the new product according to the weight, size of the box and value of the box according to specific Terms and Conditions. FIG. 5 shows an example of an SP price-list.

In some cases, the end-customer distributes internally the price-list from its selected intermediaries. It will, in this case, have to distribute the updated price-lists internally and inform the appropriate procurement units that new price-lists are available from the intermediaries R1 and R2 selected for the distributions of the products from the manufacturers A and B.

But the more the price-list includes a large number of Product or Services, the more frequent those Products or Services prices are subject to change. Since customers are price sensitive, a more frequent price-list update is resource intensive, expensive, time consuming, and a source of human error.

It is therefore of the utmost importance that the price-list is maintained up-to-date and error free.

### SUMMARY

It would be advantageous to achieve a method and apparatus which propagate any change in a price-list quickly and without error.

To better address one or more concerns, in a first aspect of the invention, a computer aided method for determining a product price comprises:
receiving a request from a first user to access a first price-list stored in a server, said first price-list comprising at least a product record comprising a product reference and a product price,
allowing access to the first price-list upon authentication of the first user,
creating a second price-list in the name of the first user,
creating a new product record into the second price-list, the new product record being linked to at least one product record of the first price-list and comprising at least a product reference and a product price,
determining the product price of the new product record from the product price contained in the linked product record of the first price-list, so that any change in the product price of the first price-list generates an update of the product price of the new product record in the second price-list.

The updated price may then be applied by a vendor to the product and sold, thereby collecting money from a purchaser of the product with the updated pricing.

The authentication of the first user may be implemented by various elements, for example, a keyboard of a computer, via which a username and password can be provided, a finger print or retinal reader or other measurement device via which biometric data can be provided, or possibly a memory of a computer comprising an authenticating security key or certificate and the like.

Advantageously, the method overcomes the prior art's difficulty to update prices though a multi-channel distribution model.

As a result, prices and price-lists for manufacturers, intermediaries or end-customers can be updated automatically in a very short time frame and can be accessed from most of the connected computers over the Web for individuals that have the appropriate access rights. This results in the reduction of operating costs and time-to-market delays and an increase in flexibility and reliability of the processes related to the creation and maintenance of prices and a price-list.

In particular embodiments:
determination of the product price comprises:
   retrieving a pricing rule associated to said first user,
   applying said pricing rule to the product price contained in the linked product record of the first price-list to determine the product price in the second price-list;
in a preliminary step, said pricing rule is defined by said first user;
the product price contained in the first price-list varies depending on the first user;
when the product price in the first price-list is modified, a notification is sent to said first user;
a third price-list is stored in a server and said first user is authorized to access said third price-list that further comprises:
   creating a second new product record into said second price-list, said second new product record being linked to at least one product record of said third price-list and comprising at least a product reference and a product price, and
   determining the product price of the second new product record from the product price contained in the linked product record of the third price-list, so that any change in the product price of the third price-list generates an update of the product price of the new product record in the second price-list.

Depending on the type of price-list environment, a particular embodiment may be preferred as easier to adapt. Aspects of these particular embodiments may be combined or modified as appropriate or desired, however.

In a second aspect of the invention, a computer program product comprises a computer usable medium having a computer readable program code embodied therein, said computer readable program code adapted to be executed to implement the method(s) previously disclosed.

In a third aspect of the invention, a computer-based server comprises computer hardware having a processor, memory, a communication element connected to a network, and algorithms having executable code designed to run on the processor that are stored in the computer memory, the server being designed as a special-purpose machine having:
a receiver that receives a request from a first user to access a first price-list stored in the server, said first price-list comprising at least a product record comprising a product reference and a product price,
an access element that allows access to said first price-list upon authentication of said first user,
a data store that stores a second price-list in the name of said first user,
a data store that stores a child product record into said second price-list, said child product record being linked to at least one product record of said first price-list and comprising at least a product reference and a product price,
a determining element that determines the product price of the child product record from the product price contained in the linked product record of the first price-list, so that any change in the product price of the first price-list generates an update of the product price of the child product record in the second price-list.

### BRIEF DESCRIPTION OF THE DRAWINGS

These and other aspects of the invention will be apparent from and elucidated with reference to the embodiment described hereafter in relation with annexed figures where:

FIG. 1 is an illustration of a basic Manufacturer A price table according to the prior art;

FIG. 2 is an illustration of a basic Manufacturer B price table according to the prior art;

FIG. 3 is an illustration of a basic Intermediary R1 price table according to the prior art;

FIG. 4 is an illustration of a basic Intermediary R2 price table according to the prior art;

FIG. 5 is an illustration of a basic Service Provider SP price table according to the prior art;

FIG. 6 is a block diagram of a computer system;

FIG. 7 is a pictorial diagram illustrating an example of extended network environment;

FIG. 8 is a flowchart of a method according to an embodiment of the invention;

FIG. 9 is a pictorial diagram illustrating the relationship between the records of a product in two related price-lists according to an embodiment of the invention;

FIG. 10 is a screen shot of an exemplary “parent e-Pricelist” creation environment;

FIG. 11 is a screen shot of an exemplary e-Pricelist validation;

FIG. 12 is a screen shot of an exemplary resulting Pricelist as a customer sees it;

FIG. 13 is a screen shot of an exemplary distribution list; and

FIG. 14 is a functional block diagram of a server implementing the method of FIG. 8.

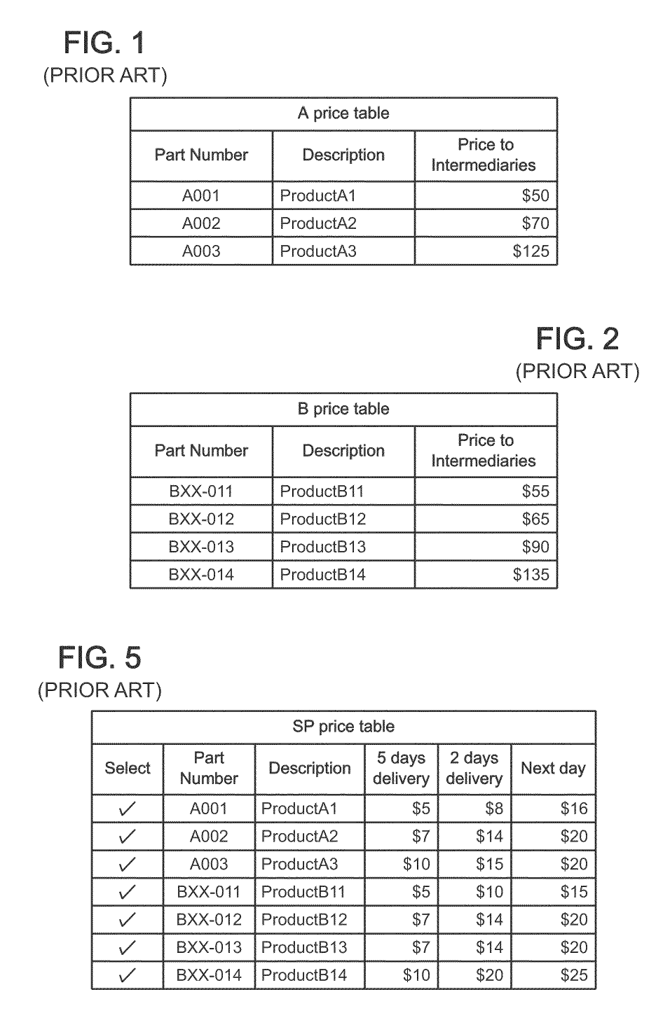

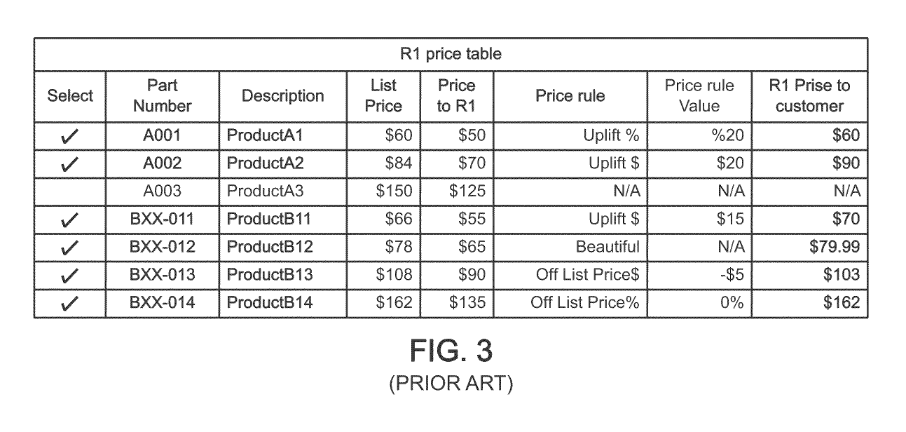

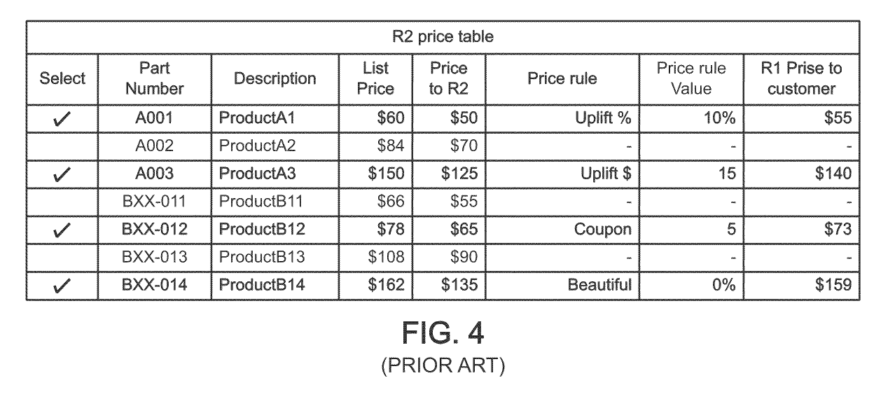

### DETAILED DESCRIPTION OF THE EMBODIMENTS

In the following description, numerous specific details are set forth in order to provide a more thorough description of the present invention. It will be apparent, however, to one skilled in the art that the present invention may be practiced without these specific details. In other instances, well-known features have not been described in detail so as not to obscure the invention.

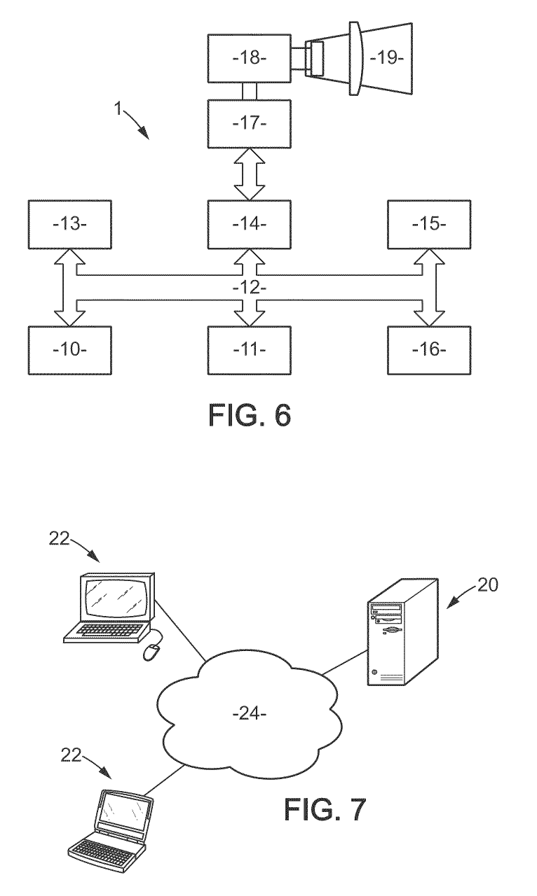

The present invention may be implemented on any conventional computer system or any system connected in network such that it becomes a special purpose computer when the software modules implementing various aspects of the invention are arranged in a specified manner on the system. An example of one embodiment of a computer system 1 for implementing the invention is illustrated in FIG. 6.

A keyboard 10 and mouse 11 are coupled to a bi-directional system 12. The keyboard and mouse allow a user input data to the computer system and communicate that user input to CPU 13. The computer system of FIG. 6 also includes a video memory 14, main memory 15 and mass storage 16, all coupled to a bi-directional system bus 12 along with a keyboard 10, mouse 11 and CPU 13. The mass storage 12 may include both fixed and removable media, such as magnetic, optical or magneto-optical storage systems and any other available mass storage technology. The mass storage may be shared on a network, or it may be a dedicated mass storage. Bus 12 may contain, for example, 32 address lines for addressing video memory 14 or main memory 15. The system bus 12 also includes, for example, a 32-bit data bus for transferring data between and among the components, such as CPU 13, main memory 15, video memory 14 and mass storage 12. Alternatively, multiplexed data/address lines may be used instead of separate data and address lines.

In one embodiment of the invention, the CPU 13 is a 32-bit microprocessor manufactured by Intel, such as Pentium processor. However, any other suitable microprocessor or microcomputer may be utilized as it is well-known from the man skilled in the art. Main memory 15 is typically composed of random access memory (RAM) and comprises 8 megabytes of memory or more, for instance. More or less memory may be used without departing from the scope of this invention. Video memory 14 may be a dual-ported video random access memory (RAM), and in this embodiment consists, for example, of 256 Kbytes of memory. However, more or less video memory may be provided as well. One port of the video memory 14 is coupled to a video multiplexer and shifter 17, which in turn is coupled to a video amplifier 18. The video amplifier 18 is used to drive the cathode ray tube (CRT) raster monitor 19. The video multiplexing shifter circuitry 17 and the video amplifier 18 are well-known in the art and may be implemented by any suitable elements. This circuitry converts pixel data stored in video memory 14 to a raster signal suitable for use by a monitor 19, which is a type of monitor suitable for displaying graphic images.

The computer system 1 described above is for exemplary purposes only. The present invention may be implemented in any type of computer system or programming or processing environment. For example, in one embodiment illustrated at FIG. 7, the invention's pricing system is implemented on a server 20 in a computer network. In that case, no keyboard, mouse, or display is required to implement the present invention—only a processor, memory, and network communications hardware. In this embodiment, the invention is typically implemented with the aid of laptops 22 or otherwise remote terminals or computers which communicate with the server via a wired or wireless connection 24, typically through Internet network.

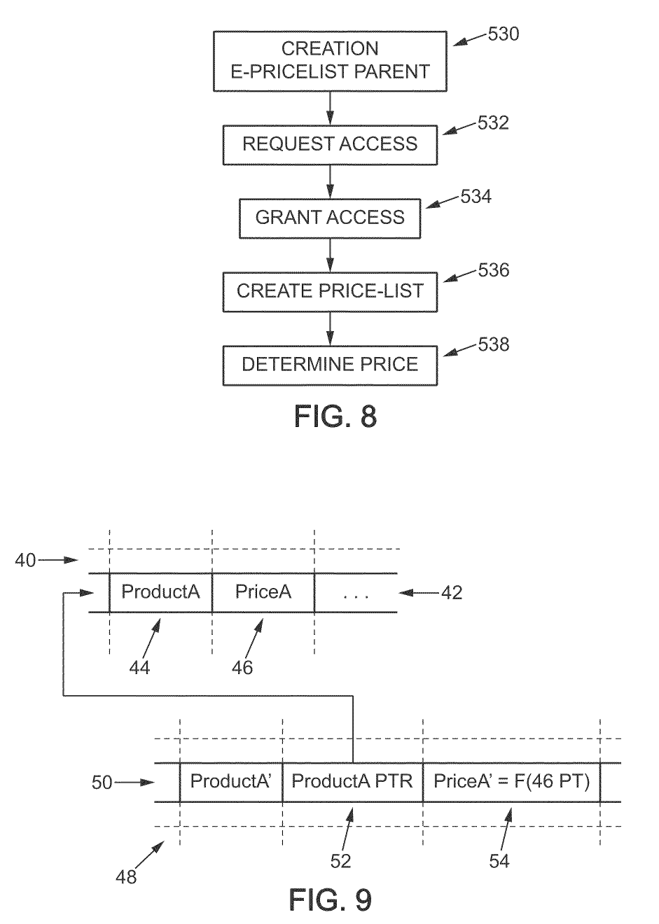

The creation and modification of price lists according to an embodiment of the invention is illustrated at FIG. 8.

In a first step S30, a user, for instance a manufacturer, creates a “parent e-pricelist” on a memory of the server 1. The “parent e-pricelist” is based, for instance, on a relational database, such as MySQL, Oracle and the like.

The “parent e-pricelist” is similar to a classical price-list as it comprises at least a record for each product of the price-list, this record comprising at least a product reference and a product price.

To organize the set of product records, a product hierarchy may be advantageously defined.

In this embodiment, the “parent e-pricelist” may comprise also a set of “Pricing Terms” comprising, for a product or a group of products, a set of pricing rules, such as margin increment, and associated pricing rule value, such as 5%. These rules may be stored in a memory and accessed by the processor.

The “parent e-pricelist” comprises also an authorization module which defines and grants access to individuals. This module enables the listed intermediaries, service providers or customers of choice to be automatically notified of price-list creation or updates and to be authorized to access the price-list.

At step S32, a user, for instance an intermediary, sends a request to access the “parent e-pricelist”, for instance after having received an update notification of the “parent e-pricelist”.

At step S34, the authorization module grants access to the “parent e-pricelist” as the user is referenced as having the corresponding rights.

At step S36, the user creates its own price-list based on the “parent e-pricelist” but with the user's own pricing terms. Therefore, for each product of interest for the user, the system, using a processor, creates a product record referencing the corresponding product record of the “parent e-pricelist” and comprising a product reference and a product price. The product reference may be the same product reference as the “parent e-pricelist” or a product reference specific to the user.

At step S38, the user determines the product price by linking dynamically the product price to the corresponding product price of the “parent e-pricelist” so that a price modification at the “parent e-pricelist” level is automatically transferred to the price list of the user and generates, eventually, a new price in the user price-list taking into account the pricing terms of the user. The linking may be achieved, e.g., by an address stored in a price record.

To illustrate the propagation of prices between price-lists, an example is shown at FIG. 9.

The “e-pricelist parent” 40 contains a record 42 for ProductA. The record 42 comprises a product reference field 44 and a product price field 46.

The user price-list 48 contains a record 50 for ProductA′, in the user codification. In fact, ProductA′ is the ProductA of the “parent e-pricelist”. Therefore, the record 50 contains a reference field 52 pointing to the ProductA record 42 of the “parent e-pricelist”.

The price field 54 for ProductA′ is a calculated field based on the price record 46 and applicable pricing terms PT defined by the user for this product or type of product.

This mechanism enables the generation and automates the maintenance of the manufacturers, intermediaries, service providers and end-customers resulting price-lists.

Those intermediaries and service providers access the system to enter into it their rules that enable the creation of their own price-lists for their intermediaries, service providers or customers of choice.

Upon request and at any time, the server enables the connected user to obtain all price-lists for which a “parent e-pricelist” owner, intermediaries or service providers would have authorized access to through listing the user in the price-list distribution list.

The embodiment enables the user to obtain the most up-to-date purchase price of a particular product from a specific vendor, and to compare the prices for a particular product from various intermediaries.

To summarize, to build the user's price-list, the user:
Selects a product as a part of a particular price-list,
Enters the price increment and related update method,
Calculates the result of the addition of the purchase price and the price increment,
Generates the new price-list by creation or update,
Selects the appropriate price-list distribution list, and
Distributes the new generated price-list and notifies the downstream price-list users.

The user price-list may become the “parent e-pricelist” for a second user, creating a cascade of price-lists in which the prices are automatically updated. Therefore, the man skilled in the art understands that the price field of the “e-pricelist parent” may be a calculated field.

The “parent e-pricelist” and user price-list may reside in a memory or memories on the same server computer, or they can be separated across memories in multiple computers, e.g., in a client-server arrangement. Notification of updates can occur through application-generated events, either within the server, or across multiple computer systems using event notification or messaging. The end-user can be notified of updates via any messaging protocol, such as e-mail, SMS messaging and the like.

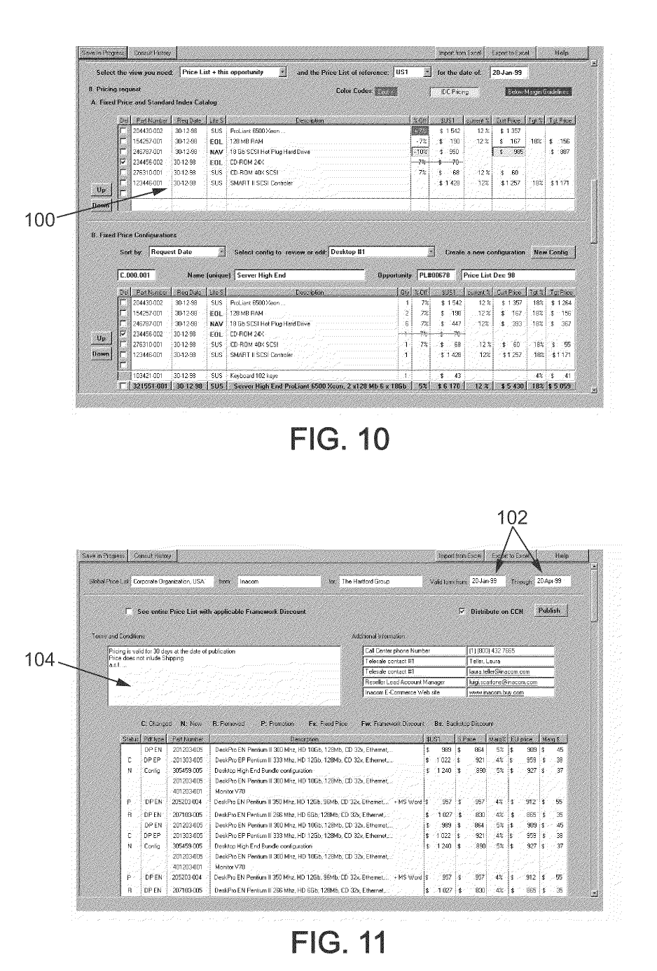

As example, FIGS. 10 to 16 show some computer screens of a particular embodiment.

FIG. 10 shows two computer screens for creation of a “parent e-pricelist”. The window 100 shows, for a list of 6 products, the price terms as a reduction rate defined as percentage.

FIG. 11 illustrates a validation screen on which a validity period is defined in panel 102 and terms and conditions on panel 104.

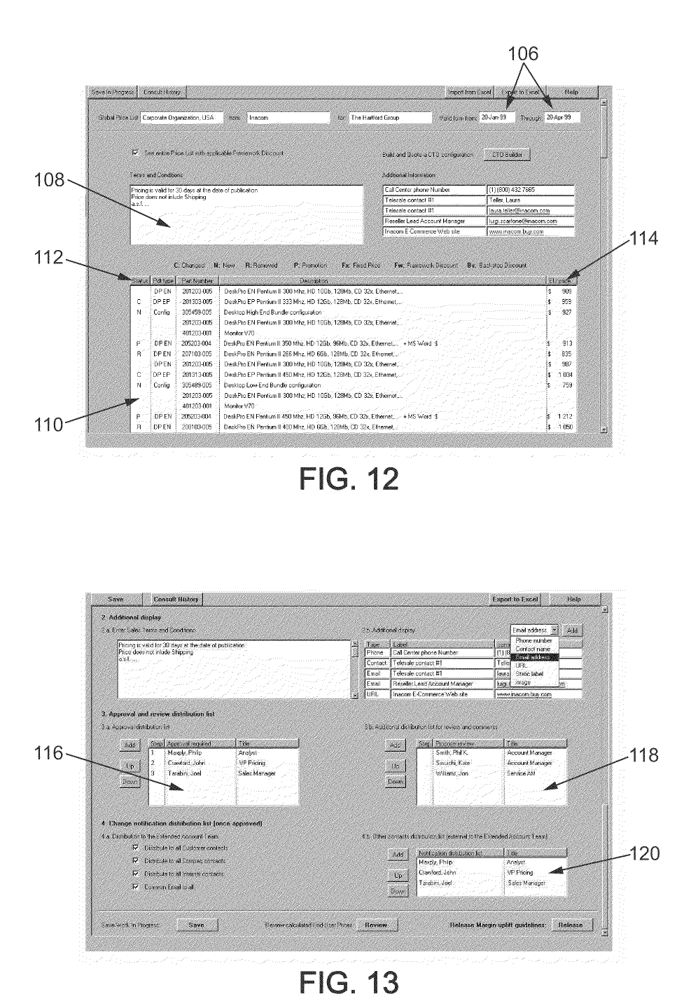

The equivalent screen for the end-customer is illustrated at FIG. 12. Validity period and terms and conditions are reproduced on panels 106 and 108 respectively. The price list itself is listed in panel 110. The price list contains a “status” column 112 defining for each product line the type of modification such as “creation”, “update”, “promotion”, etc.

Compared to the same panel of FIG. 11, the panel 110 contains only the customer price at column 114 whereas the panel for the validation screen contains other pricing information such as margin.

FIG. 13 illustrates a distribution list screen with three different distribution lists: an approval distribution list 116, a review distribution list 118 and an external distribution list 120.

To summarize, each price-list of a participant in the chain of distribution and sales of a product is connected to the other price-lists, product per product, in such a way that any modification of a price, or a condition an a price in a price-list generates an update of all prices for the concerned product in all children price-lists. Thus, the disclosed method and associated server advantageously reduce the burden of manually updating price-lists with the errors that such a manual update may generate.

The disclosed method may advantageously be implemented by software. A computer program product comprises instructions which, when executed by data processing apparatus, for instance the server 20, causes the data processing apparatus to perform the disclosed method.

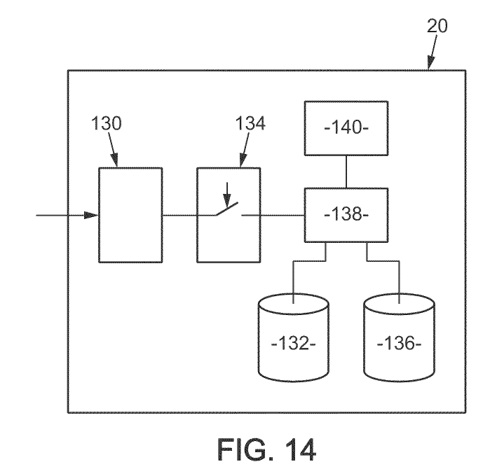

Functionally, the server 20, FIG. 14, comprises:
a receiver 130 that receives a request from a first user to access a first price-list 132 stored in the server, said first price-list comprising at least a product record comprising a product reference and a product price,
an access element 134 that allows access to said first price-list upon authentication of said first user,
a data store 136 that stores a second price-list in the name of said first user,
a data store 138 that stores a child product record into said second price-list, said child product record being linked to at least one product record of said first price-list and comprising at least a product reference and a product price,
a determining element 140 that determines the product price of the child product record from the product price contained in the linked product record of the first price-list, so that any change in the product price of the first price-list generates an update of the product price of the child product record in the second price-list.

While the invention has been illustrated and described in details in the drawings and foregoing description, such illustration and description are to be considered illustrative or exemplary and not restrictive; the invention is not limited to the disclosed embodiment.

For instance, each price-list may be contained in a database on a unique server as shown in the described embodiment, or may be distributed in different databases on different servers, the communication between databases using some web services, for instance.

Other variations to the disclosed embodiments can be understood and effected by those skilled on the art in practicing the claimed invention, from a study of the drawings, the disclosure and the appended claims. In the claims, the word “comprising” does not exclude other elements and the indefinite article “a” or “an” does not exclude a plurality.

The system or systems may be implemented on any form of computer or computers and the components may be implemented as dedicated applications or in client-server architectures, including a web-based architecture, and can include functional programs, codes, and code segments. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions or computer readable codes executable on the processor on a computer-readable media such as read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. This media can be read by the computer, stored in the memory, and executed by the processor.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context.

Numerous modifications and adaptations will be readily apparent to those skilled in this art without departing from the spirit and scope of the present invention.

What is claimed is:

1. A computer-aided method for determining a product price, comprising
receiving a request from a first user to access a first price-list stored in a memory of a server, the first price-list comprising at least a product record comprising a product reference and a product price;
authenticating the first user with the server via an authentication element;
allowing access to the first price-list upon authentication of the first user;
creating a second price-list in the name of the first user;
creating a new product record into the second price-list, the new product record being linked to at least one product record of the first price-list and comprising at least a product reference and a product price;
determining the product price of the new product record from the product price contained in the linked product record of the first price-list;
changing the product price in the first price-list; and
automatically updating the product price of the new product record in the second price-list.

2. The method of claim 1, wherein determination of the product price comprises:
retrieving a pricing rule associated to the first user; and
applying the pricing rule to the product price contained in the linked product record of the first price-list to determine the product price in the second price-list.

3. The method of claim 2, wherein, in a preliminary step, the pricing rule is defined by the first user.

4. The method of claim 1, wherein the product price contained in the first price-list is varying depending of the first user.

5. The method of claim 1, wherein, when the product price in the first price-list is modified, a notification is sent to the first user.

6. The method of claim 1, wherein a third price-list being stored in a server and the first user being authorized to access the third price-list, further comprises:
creating a second new product record into the second price-list, the second new product record being linked to at least one product record of the third price-list and comprising at least a product reference and a product price; and
determining the product price of the second new product record from the product price contained in the linked product record of the third price-list, so that any change in the product price of the third price-list generates an update of the product price of the new product record in the second price-list.

7. A computer program product, comprising a computer usable medium having a computer readable program code embodied therein, the computer readable program code adapted to be executed to implement the method according to claim 1.

8. A server, comprising:
a receiver that receives a request from a first user to access a first price-list stored in a memory of the server, the first price-list comprising at least a product record comprising a product reference and a product price;
an authentication element that authenticates the first user with the server;
an access element permitting access to the first price-list upon authentication of the first user;
a memory that stores a second price-list associated with the first user, the second price-list comprising a child product record comprising at least a product reference and a product price; and
an algorithm that determines the product price of the child product record from the product price contained in the linked product record of the first price-list, the algorithm generating an update of the product price of the child product record in the second price-list when the product price of the first price-list is changed.

9. A server, comprising:
a processor, memory, and a communication element connected to a network;
a receiver that receives a request from a first user to access a first price-list stored in a memory of the server, the first price-list comprising at least a product record comprising a product reference and a product price;
an authentication element that authenticates the first user with the server;
an access element permitting access to the first price-list upon authentication of the first user;
a memory that stores a second price-list associated with the first user, the second price-list comprising a child product record comprising at least a product reference and a product price;
a linkage element that links the child product record to at least one product record of the first price-list;
an algorithm that determines the product price of the child product record from the product price contained in the linked product record of the first price-list, the algorithm generating an update of the product price of the child product record in the second price-list when the product price of the first price-list is changed; and
a further communication element that transmits an indication of the update of the child product record in the second price-list to the first user.

10. The method of claim 1, further comprising:
applying the updated product price in the second price-list to a product represented by the product reference; and
selling the product and receiving money associated with the sale.
